(19) United States
(12) Patent Application Publication
(10) Pub. No.: US 2014/0312138 A1
(43) Pub. Date: Oct. 23, 2014

(54) Impingement Fan Display

(71) Applicants: Mark Fuller, Sun Valley, CA (US); Jim Doyle, Sun Valley, CA (US); Keith Kalis, Sun Valley, CA (US); Amnon Talmor, Sun Valley, CA (US)

(72) Inventors: Mark Fuller, Sun Valley, CA (US); Jim Doyle, Sun Valley, CA (US); Keith Kalis, Sun Valley, CA (US); Amnon Talmor, Sun Valley, CA (US)

(21) Appl. No.: 14/214,507

(22) Filed: Mar. 14, 2014

Related U.S. Application Data
(60) Provisional application No. 61/799,641, filed on Mar. 15, 2013.

(51) Int. Cl. B05B 17/08

(52) U.S. Cl. CPC B05B 17/08
USPC 239/17

(57) ABSTRACT

An impingement fan water display that may be used in a water display is described. The device may include two nozzles that project streams of water towards each other in an intersecting trajectory and impinge upon each other. The angle of orientation of the nozzles in relation to each other may be varied to produce varying water stream fan widths and shapes. A plate may be located at or near the point of impingement.

### CROSS REFERENCE TO RELATED APPLICATION

The application claims the benefit of U.S. Provisional Application No. 61/799,641, filed Mar. 15, 2013, the contents of which are incorporated herein by reference.

### FIELD OF THE INVENTION

The present invention generally relates to water displays, including the control of streams of water to produce visual effects. For example, two streams of water may be directed at each other at an angle to produce a fan pattern.

### BACKGROUND OF THE INVENTION

Various types of water displays exist, and existing water displays may include water delivery devices and/or nozzles that shoot water out in different configurations. Sometimes, existing water displays may include a number of such devices or nozzles. For example, existing water shooters may shoot a column of water out of a round pipe. Alternatively, a nozzle may be fitted to the water delivery device that has an outlet or opening through which water is shot. The nozzle may have a particular shape so that the water shot out of the nozzle assumes the configuration of that shape. For example, a nozzle may have an opening that shoots out water in a fan shape.

In any event, using nozzles and other hardware to produce visual water display effects may involve cost and set-up time that may lead to difficulty. Furthermore, most nozzles are fixed in their shape so that only one configuration of water may be shot out of the nozzle. This may limit the visual effects provided by the water nozzle and the overall water display.

Accordingly, there is a need for an arrangement and a method to produce desired water configuration without necessarily having to use a nozzle or other hardware to produce the desired visual effect. There is also a need to produce desired water configurations that may be varied during a performance.

### SUMMARY OF THE INVENTION

In an aspect of the invention, two streams of water may be directed at each other at a desired angle so that they impinge on each other and between them form a fan-shaped water stream. This preferably occurs without having to use a fan-shaped nozzle or other hardware that may typically be used to produce that visual effect. In this manner, the current invention allows dramatic visual effects to be easily produced without the need for hardware and its associated cost and set-up time.

In another aspect of the invention, two round water streams may impinge on each other at an angle to form a fan shaped water stream. The “width” of the fan may be altered by changing the angle of impingement and/or the water pressure of the streams impinging on each other.

In another aspect of the invention, the form of the fan may be altered by positioning a planar element or piece of material, such as a plate, at the point where the two streams of water impact, in a manner that is co-planar with the resultant fan. This may generally “clean up” the appearance of the fan. To this end, a thin piece of clear acrylic may be used to produce this effect. The planar element may be rigid or flexible.

In another aspect of the invention, the appearance of the water fan may be altered in a controlled manner. For example, the use of the piece of flat or planar material mentioned above may help transform the fan to a round stream and back by turning one stream off (and withdrawing the plate). The round stream may be at half the included angle relative to the plane of the fan. But if that is not desirable, the appearance may be changed where the entire assembly producing the water stream is located on a device or other moving assembly.

### BRIEF DESCRIPTION OF THE DRAWINGS

FIG. 1 is a side view of an arrangement where round streams of water may impinge on each other at an angle to form a fan.

FIG. 2 is a side view of this arrangement with an optional plate positioned where the water streams impinge.

FIG. 3 is a front view of a water stream fan.

FIG. 4 is a front view of a water stream fan.

FIG. 5 is a front view of a water stream fan.

FIG. 6 is a front view of a water stream fan.

FIG. 7 is a front view of a water stream fan.

### DETAILED DESCRIPTION OF THE PREFERRED EMBODIMENTS

The current invention is now described with reference to the figures. Components appearing in more than one figure bear the same reference numerals. The invention is described herein with reference to water. However, the use of other fluids and combinations thereof are within the scope of the invention.

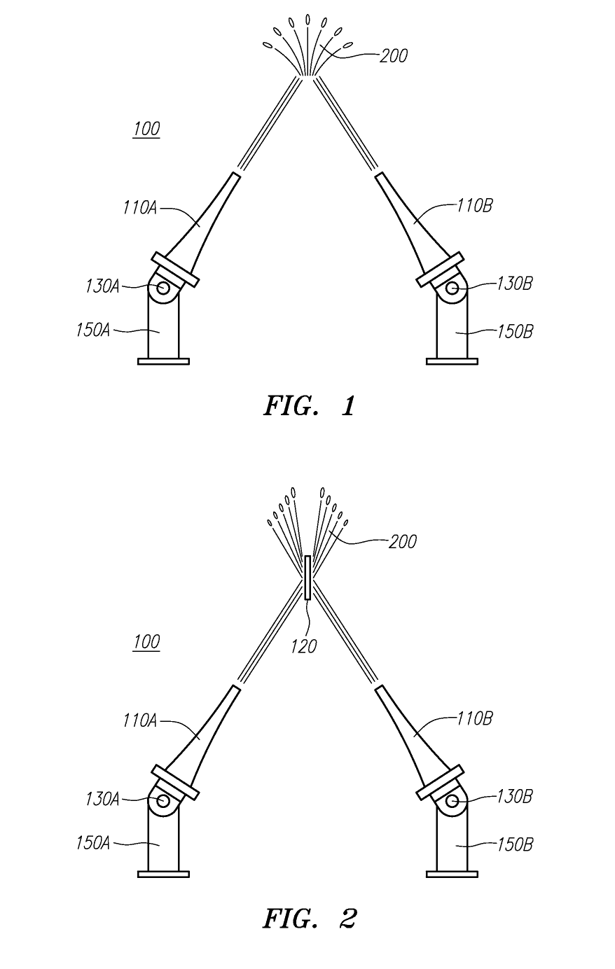

An embodiment of the current invention where an impingement water stream fan 200 is produced is now described with reference to FIGS. 1 and 2. Impingement fan 200 may be produced by an arrangement 100 where water is shot out of nozzles 110A, 110B so that they impinge on each other at a desired angle. Nozzles 110A, 110B may be fed by water input tubes 150A, 150B to deliver water at a desired pressure so that fan 200 may be formed. With reference to FIG. 1, the plane of fan 200 generally extends into the page, or transverse to the directions at which the water is shot out of nozzles 110A, 110B.

The width of fan 200 may be altered by changing the angle at which the two streams of water impinge on each other. In a preferred embodiment, the angle of impingement is a relatively small included angle. Increasing this angle may widen the fan 200 while decreasing this angle may narrow the fan 200.

As shown in FIG. 2, arrangement 100 may include an optional planar element, such as plate 120, that may be positioned at the point where the two water streams impinge on each other. As shown, planar element or plate 120 is preferably positioned so that it is co-planer with the fan 200 it helps create. It is preferred that plate 120 comprise a clear material so as to reduce or minimize its visual presence to the observer so that it does not detract from the fan 200. It is also preferred that plate 120 be durable to withstand the forces imparted to it by the impinging water streams. However, planar element or plate may be rigid or flexible.

Planar element or plate 120 may generally “clean up” the fan 200 by directing the two streams of water upward and outward in a more orderly fashion, i.e., as opposed to the two streams of water just crashing into each other. However, dramatic visual effects may still be provided by the fan 200 that is formed without plate 120.

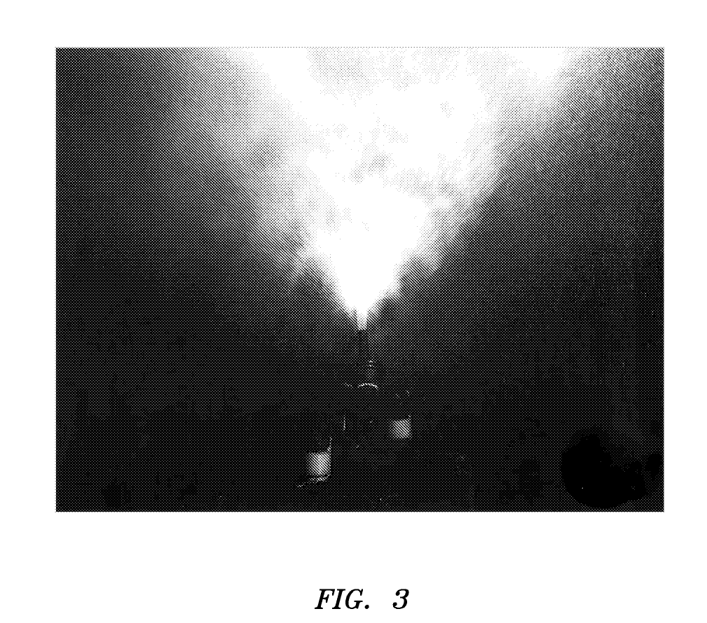

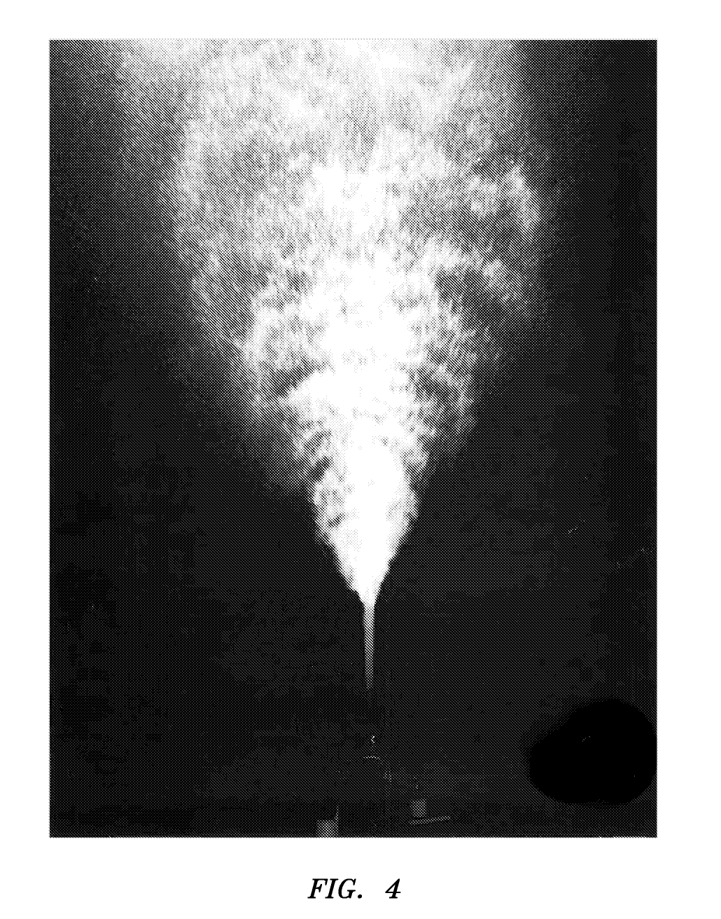

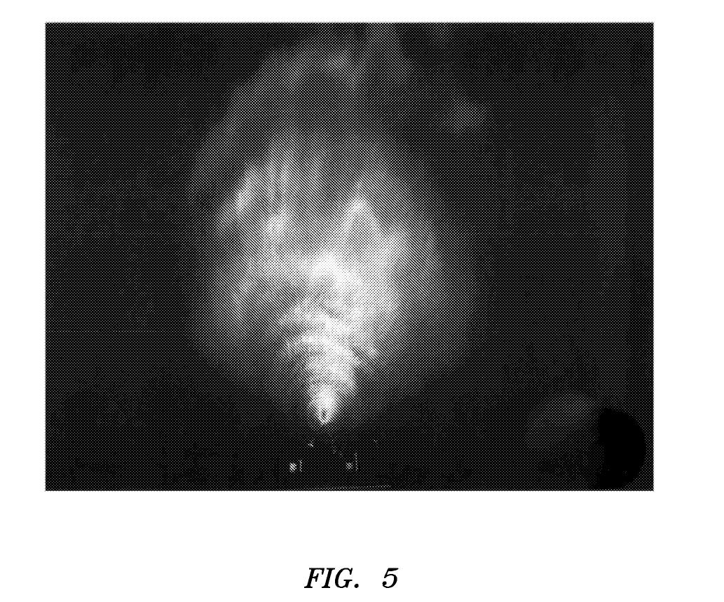

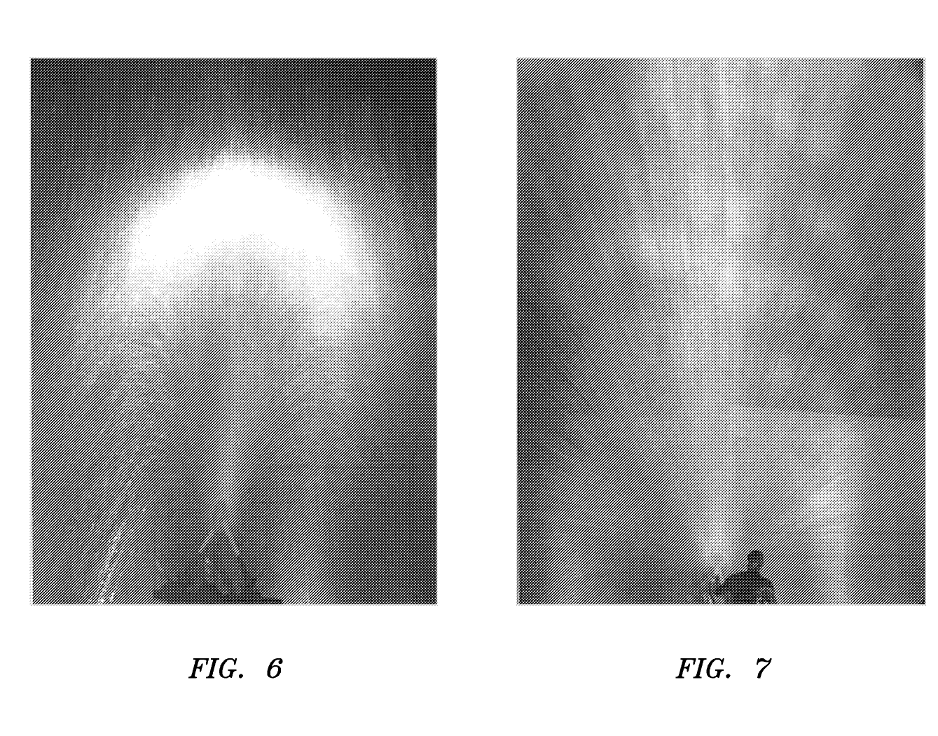

The effect of planar element or plate 120 may be seen by comparing the fans 200 of FIGS. 3 and 4 to the fans of FIGS. 6 and 7. A shown in FIGS. 6 and 7, a plate 120 is installed at the point of impingement, and the resulting fan 200 is more refined in its appearance.

Plate 120 may be shaped in a form other than flat in order to modify the shape of water stream fan 200. Examples of possible alternative shapes are convex, concave, corrugated, flat with texture and flat with holes. Each of these alternate shapes may also introduce lateral variations in the form of the water stream fan, thereby offering the user increased creative possibilities.

It is preferred that the shape of fan 200 may be varied. For example, nozzles 110A, 110B may be rotated around nozzle pivots 130A, 130B in an upward or downward direction, thereby varying the angle in relation to each other. This motion may dynamically produce varying shapes of water stream fan 200. This motion may be accomplished in unison between the nozzles 110A, 110B.

Another example of the variability aspect of this invention is that by varying the water pressure being pumped through the water input tubes 150A and 150B into the nozzles 110A, 110B, different sized and different shaped water stream fans may result. The water pressure may be varied as may the angle of impingement to produce various configurations of fan 200. To this end, the angle at which nozzles 110A, 110B may be in relation to each other may be varied during use so as to allow the water stream fan 200 to vary in shape and intensity. Accordingly, by simply changing the direction of the two water streams, the appearance of fan 200 may be varied.

The outlets of nozzles 110A, 110B may be round in standard form, or may be shaped in other configurations such as rectangular, square or oval, thereby increasing the variety in water stream shape and resultant fan 200.

Nozzles 110A, 110B may be shut off and turned back on at varying intervals in order to produce a varying combination of water pulses thereby creating varying segmented water stream fan shapes. For example, fan 200 may be transformed to a round stream and back by switching one stream off and withdrawing the plate 120. The round stream may be at half the included angle relative to the plane of fan 200. If that is not desired, the configuration may be quickly changed where arrangement is located on a frame or other moving assembly.

To this end, the arrangement 100 comprising nozzles 110A, 110B and its associated hardware may be supported on a mount that may rotate horizontally around a first axis and tilt back and forth on another axis. These rotating and tilting motions may yield water stream fans that appear dynamic and three dimensional, versus the resulting water stream fans from other statically mounted water display devices. A motor handling both horizontal and vertical axis motions may be installed as part of the impingement fan arrangement 100 and may be remotely controlled.

Nozzles 110A, 110B and/or input tubes 150A, 150B may include within them valves that may be adjustable during a water show for the purpose of controlling the water flow through the nozzle, hence controlling the water stream fan shapes, sizes and water pulses during said show. These valves may be remotely controlled.

While the foregoing description pertains to an embodiment involving the streams of water that impinge upon each other to produce a fan-shaped water stream, the current invention includes three or more streams of water impinging upon each other to produce a resulting water stream. In this embodiment, a plate, that may have a number of surfaces corresponding to the number of streams, may be located at or near the location of impingement.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A water display, comprising:
streams of water that impinge upon each other at an angle;
wherein the impingement produces a fan-shaped water stream.

2. The display of claim 1, further comprising:
a planar element positioned at or near the location where the streams of water impinge upon each other.

3. The display of claim 1, wherein the angle of impingement is varied, thereby varying the shape of fan-shaped water stream.

4. The display of claim 1, wherein at least one of the streams of water is turned off and on.

5. A water display, comprising:
at least two streams of water that impinge upon each other at an angle to produce a fan-shaped water stream;
wherein each of the at least two streams impinge upon each other at a water pressure;
wherein the fan-shaped water stream is altered by changing the angle of impingement and/or the water pressure of at least one of the streams of water.

6. The water display of claim 5, further comprising a planar element positioned at or near the location where the at least two streams impinge upon each other.

7. The water display of claim 6, wherein the planar element is positioned to be co-planar with the fan-shaped water stream.

8. The water display of claim 6, wherein the planar element is a plate.

9. The water display of claim 6, wherein the planar element is clear.

10. The water display of claim 6, wherein the planar element is withdrawn.
